(19) United States
(12) Patent Application Publication
(10) Pub. No.: US 2015/0097047 A1
(43) Pub. Date: Apr. 9, 2015

(54) Method for controlling and managing smart atomizer

(71) Applicants: Chin Chien Hu, Taichung (TW); Jih Wen Wang, Taichung (TW); Ting-Kuo Chen, Taichung (TW); Jey Jey Huang, Taichung (TW)

(72) Inventors: Chin Chien Hu, Taichung (TW); Jih Wen Wang, Taichung (TW); Ting-Kuo Chen, Taichung (TW); Jey Jey Huang, Taichung (TW)

(21) Appl. No.: 14/572,786

(22) Filed: Dec. 17, 2014

(51) Int. Cl. B05B 17/06

(52) U.S. Cl. CPC B05B 17/0653
USPC 239/4

(57) ABSTRACT

A method for controlling and managing a smart atomizer involves automatically frequency tracing to rapidly optimize an operating frequency of a piezoelectric element of a spray nozzle when the spray nozzle is assembled to a main machine of the smart atomizer. The main machine performs spray-dosage setting, so that each spray session can operate according a preset spray dosage, so as to provide consistent spray of liquid easily. While the liquid is sprayed, the frequency-abnormality detecting means keeps detecting whether there is any abnormality of the operating frequency of the piezoelectric element. Thereby, whether the spray nozzle works normally can be easily confirmed by whether a frequency-tracing prompter gives out a prompt and what maintenance message is contained in the prompt. The method also includes event recording and external record reading for storing, exporting and leveraging data about usage of the atomizer for improved usage of the atomizer.

### BACKGROUND OF THE INVENTION

1. Field of the Invention

The invention relates to methods for controlling and managing atomizers, and more particularly to a method for controlling and managing a smart atomizer featuring that when a spray nozzle is assembled to the atomizer the operating frequency of its piezoelectric element can be optimized automatically, that consistent spray of every spray session can be easily achieve; that it is possible to detect whether the operating frequency remains optimal throughout the spray operation; and that the usage of the atomizer can be recorded and used by external resources.

2. Description of Related Art

As MEMS (Micro Electro-Mechanical System) technology has advanced rapidly, the recently developed drug dispensing atomizers are made to generate extremely fine mist of medicine particles that is helpful to enhance inhalation and curative effects. These atomizers are made portable and thus are convenient for various patients to use. However, a spray nozzle on the known atomizer tends to get clogged after long-term use and its cleaning is troublesome. As an improvement, atomizers with replaceable spray nozzles have been proposed for ensuring not only normal nebulization, but also use hygiene and safety.

The atomizers with replaceable spray nozzles, however, have their challenges. For example, one technical issue encountered when it comes to replacement of spray nozzles is about the piezoelectric enabling element of the spray nozzle. Since different materials and different porous metal nozzle plates have different (inconsistent) vibrational properties, it is essential to have the piezoelectric element properly adjusted in terms of operating frequency, or normal nebulization is impossible. For addressing this issue, a known scheme proposed is about directly getting feedback signals from the piezoelectric element (by using, for example, a vibration sensor) and accordingly performing frequency adjustment, yet the feedback signals are usually not accurate enough and likely to lead to fault detection. As a further improvement, a disclosure discloses a nebulizing device with a detachable spray nozzle, wherein variable resistance or variable capacitance (to be manually adjusted) is used to properly set the operating frequency for the piezoelectric element. Nevertheless, in practical use, users (consumers) of the atomizer when doing adjustment without the aid of any electric detecting instruments has no scientifically-proven data as reference and can hardly identify the optimal operating frequency. Given the required manual adjustment and uncertain adjusted results, this known approach is somehow inconvenient. Another disclosure discloses an adjusting method and structure for resonance frequency of a demounting type spray head of an atomizer. It implements microcomputer frequency tracing technology to automatically align the operating frequency the piezoelectric element with its resonance frequency, and effectively eliminates the inconvenience and inaccuracy related to manual adjustment. The frequency tracing technology can fix the newly assembled spray nozzle to the aligned operating frequency, and secure the piezoelectric element to work with this frequency throughout all sequent spray sessions. However, in the event that the piezoelectric element or the nozzle plate becomes unable to atomize the liquid it sprays to the desired level, the atomizer provides no means to detect this situation and readjust the operating frequency of the piezoelectric element accordingly.

It is known that good medicine inhalation and curative effects depend on the fine mist of atomized medicine generated by atomizers. As an untrained user is usually unable to tell the subtle difference between the original and degraded nebulization by his/her bear eyes, the deterioration can remain undetected until more significant difference occurs and this means a long period of ineffective or poor inhalation treatment has lapsed. For example, a nozzle plate is gradually clogged over a long period opposite to being blocked to the extent that it shows obvious abnormality instantly. Generally, once the nozzle plate is clogged, even slightly, the frequency on which it combines with the piezoelectric element begins or has begun to change, and the original operating frequency fixed by the microcomputer may become or have become no more optimal for resonance, leading to deterioration of nebulization. The deterioration increases and becomes more obvious as the nozzle plate is clogged more seriously. When the nebulization is too poor and it is found that the spray nozzle has to be replaced, the piezoelectric element may have worked with a non-resonant frequency for a considerable period. Consequently, the user using this atomizer receives little or no treatment through inhalation during this period. Therefore, it would be desired that the atomizer can keep checking whether the operating frequency of its piezoelectric element reaches resonance throughout operation and timely readjust the operating frequency to compensate any deterioration. Additionally, in an atomizer capable of detecting whether its piezoelectric element works on resonance, as long as the abnormality of the piezoelectric element related to misalignment to the resonance frequency is not caused by serious deformation, breakage, or manufacturing/assembling defects of the piezoelectric element and/or the nozzle plate, it can be corrected by using a microcomputer in the atomizer to use frequency tracing function to realign the operating frequency with the current resonance frequency, so the atomizer can always works normally.

Another problem of the conventional atomizers is that its user can only depend on the graduation on the container of the atomized liquid or his/her experience to determine the spray dosage in a spray session. Without scientifically proven data as reference, the resultant spray dosage tends to be too much or to less and varies cross different sessions, leading to either waste of the medicine or poor curative effects. Moreover, since the conventional atomizers lack for automatic recording function, when a caregiver or medical professional needs to know the user's use behavior, the only information available would be the user's manual record or oral report made from his/her memory. Since such information is likely to have errors or lack for integrity, any sequent treatment decision made accordingly has a high risk of impropriety. For a user who needs the use record to claim his/her medial expense from the insurance company, the manual record or oral report may be not sufficient to prove his/her proper use of medication. Not to mention that the relevant pharmaceutical businesses and/or atomizer manufactures lose useful information about the use of medicine and atomizers.

### SUMMARY OF THE INVENTION

One primary objective of the invention is to provide a method for controlling and managing a smart atomizer, being applied to a main machine of the atomizer to control and manage usage of atomized liquid at a spray nozzle, and comprising: automatically frequency tracing, involving: with electrical connection of the spray nozzle on the main machine, progressively sending out a preset frequency and plural detecting frequencies from a microcomputer in the main machine by operating a frequency-tracing switch; and amplifying the frequencies gradually using a power amplifying unit and driving a piezoelectric element of the spray nozzle to operate; making a current-feedback-signal generating unit use a resistor to detect variation of an electrical signal in an electrical connection line between the power amplifying unit and the piezoelectric element, and generate an initial feedback signal for each the variation and plural modulation feedback signals for the microcomputer to perform comparison and process, so that the microcomputer uses a frequency-tracing way to take the preset frequency or one of the detecting frequencies as an operating frequency that is optimal for the piezoelectric element, and automatically performs resonant-frequency adjustment for the piezoelectric element; main machine setting, involving performing at least date/time setting and spray-dosage setting by the microcomputer using setting-menu display of a display and operation of a setting button, wherein the date/time setting involves setting or calibrating a date and a time where the atomizer is used, and the spray-dosage setting involves setting a dosage of the atomized liquid dispensed during a spray session activated by a spraying switch; abnormality detecting, involving using at least a frequency-abnormality detecting means that comprises two resistors that are on an alternating current line between the power amplifying unit and the piezoelectric element and are connected in parallel to the piezoelectric element to detect variation of an electrical signal between the two resistors in a connection line between the two resistors through a voltage-feedback-signal generating unit; and using a current/voltage phase-comparing circuit to obtain a current-waveform feedback signal from the current-feedback-signal generating unit and a voltage-waveform feedback signal from the voltage-feedback-signal generating unit that are compared and processed to generate a signal for determining current/voltage phase difference for the microcomputer, so that the microcomputer triggers a frequency-tracing prompter when the operating frequency of the piezoelectric element is abnormal to inform that the operating frequency of the piezoelectric element has to be adjusted by operating the frequency-tracing switch or by replacing the spray nozzle; event recording, involving using a memory built in the microcomputer to record at least starting and ending date/time/spray dosage for every the spray session and date/time of each abnormality occurrence of the operating frequency; and external record reading, involving connecting a communication port at a signal input/output end of the microcomputer with an external Internet-accessing device, so as to read out data stored in the memory of the microcomputer. With the method described above, the atomizer uses automatically frequency tracing to rapidly optimize an operating frequency of a piezoelectric element of a spray nozzle when the spray nozzle is assembled to a main machine of the smart atomizer. The main machine performs spray-dosage setting, so that each spray session can operate according a preset spray dosage, so as to provide consistent spray of liquid easily. While the liquid is sprayed, the frequency-abnormality detecting means keeps detecting whether there is any abnormality of the operating frequency of the piezoelectric element. Thereby, whether the spray nozzle works normally can be easily confirmed by whether a frequency-tracing prompter gives out a prompt and what maintenance message is contained in the prompt. The method also includes event recording for storing data related to the use of the atomizer and external record reading for allowing an Internet-accessing device to read out the stored data and/or upload the data to a website for further use. Thereby, external resources can refer to the data and provide relevant assistance to improve the use of the atomizer.

Another objective of the invention is to provide a method for controlling and managing a smart atomizer, wherein instead of using the frequency-tracing prompter, the microcomputer is configured to show a frequency-abnormality signal through the display when the operating frequency of the piezoelectric element is abnormal so as to provide the same prompting effect for frequency tracing.

Another objective of the invention is to provide a method for controlling and managing a smart atomizer, wherein the main machine setting further comprises spray-alarm setting that involves setting a reminding time for using the atomizer every day and when the reminding time is up, making the microcomputer trigger a timed reminder to operate. Thereby, every day at the time for a user to use the atomizer, the timed reminder can remind the user of inhalation.

Another objective of the invention is to provide a method for controlling and managing a smart atomizer, wherein the abnormality detecting further comprises power-abnormality detecting that involves taking a battery-level detecting circuit that is configured to detect a power level of a battery as a signal input end of the microcomputer, and taking a power reminder as a detecting end of the microcomputer. Thereby, when the battery level becomes low and may hinder the piezoelectric element from normal operation, the battery-level detecting circuit can detect this situation and let the microcomputer trigger the power reminder to inform the user that the battery needs to be replaced with a new one, or the atomizer may fail to work. Alternatively, instead of using the power reminder, when the battery-level detecting circuit detects that the battery level is low, the microcomputer can show a low-power message through the display so as to remind the user of replacing the battery similarly.

Another objective of the invention is to provide a method for controlling and managing a smart atomizer, wherein the abnormality detecting further comprises liquid-lack detecting that involves using a liquid-level sensor in a liquid reservoir of a liquid refill of the spray nozzle as an input end of a liquid-level detecting circuit, wherein the liquid-level detecting circuit has an output end electrically connected to the microcomputer, and a liquid-level reminder is used as an output end of the microcomputer. Thereby, when the liquid in the liquid reservoir of the liquid refill gets consumed to a certain extent, the liquid-level detecting circuit can output a low-level signal to the microcomputer according to the detection of the liquid level in the liquid reservoir performed by the liquid-level sensor, so that the microcomputer can trigger the liquid-level reminder, to inform that refill needs to be done. When the liquid reservoir is almost empty, the microcomputer can even stops the spraying switch and automatically turns off the piezoelectric element, so as to prevent the piezoelectric element and/or the nozzle plate from getting damaged due to waterless operation. When the liquid-level detecting circuit outputs the low-level signal to the microcomputer, the microcomputer can show the low-water message through the display so as to eliminate the use of the liquid-level reminder and similarly provide refill reminding function.

Another objective of the invention is to provide a method for controlling and managing a smart atomizer, wherein the spray-dosage setting performed by the main machine setting involves making the microcomputer automatically time a period for each the spray session since a time point on which the spraying switch is turned on so as to decide the starting and ending time for the spray session as defaults, and control a total dispensed amount of one the spray session from the starting time to the ending time by setting a total spray time according to a spray flow as a constant and a statistic relation that the spray flow multiplied by the period is the spray dosage. With this function, each spray session can be controlled to give equivalent liquid dispensation by automatically timing the specified or accumulated operation time of the spraying switch.

Still another objective of the invention is to provide a method for controlling and managing a smart atomizer, wherein the spray-dosage setting performed by the main machine setting involves making the microcomputer automatically time a period for each the spray session since a time point on which the spraying switch is turned on so as to decide the starting and ending time for the spray session as defaults, and control a time length required by delivering a total dispensed amount of one the spray session from the starting time to the ending time by setting a total spray time according to a spray flow as a constant and a statistic relation that the spray flow multiplied by the period is the spray dosage. With this function, each spray session can be controlled to give equivalent liquid dispensation by automatically timing the specified or accumulated operation time of the spraying switch.

Yet another objective of the invention is to provide a method for controlling and managing a smart atomizer, wherein the communication port allowing the data to be read out is a Bluetooth port and/or a USB port, and the Internet-accessing device connected to the communication port for reading out the data is a smartphone, a laptop PC or a desktop PC that is preloaded with an operational application. By operating the application, the record data stored in the memory of the microcomputer can be read out for direct use or be uploaded to a website where the user has registered through Internet connection for remote external resources to use.

The above and other objects, features and advantages of the invention will become apparent from the following detailed description taken with the accompanying drawings.

### BRIEF DESCRIPTION OF THE DRAWINGS

FIG. 1 is a perspective view of an atomizer according to one embodiment of the invention;

FIG. 2 is a cross-sectional view of the atomizer of FIG. 1;

FIG. 3 is a block diagram of a system performing a controlling and managing method of the atomizer according to the invention;

FIG. 4 is a block diagram showing the setting flow of the controlling and managing method;

FIG. 5 is a block diagram showing details of event recording of the controlling and managing method; and

FIG. 6 is an exploded view of the atomizer of FIG. 1.

### DETAILED DESCRIPTION OF THE INVENTION

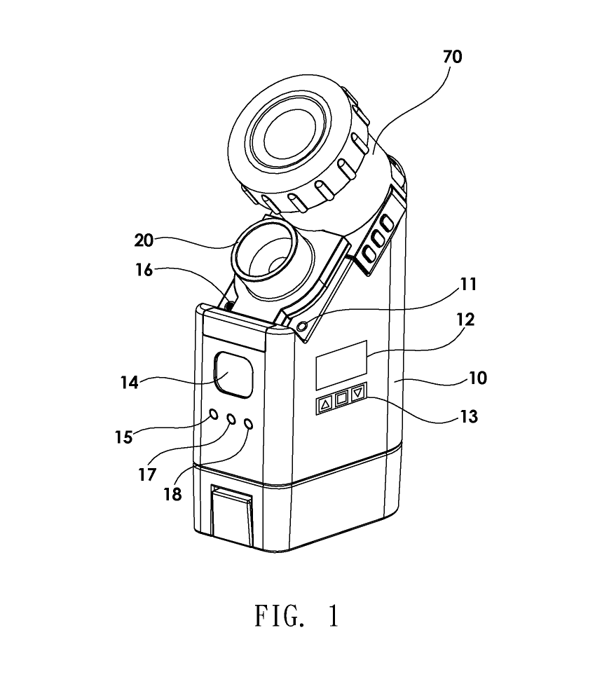

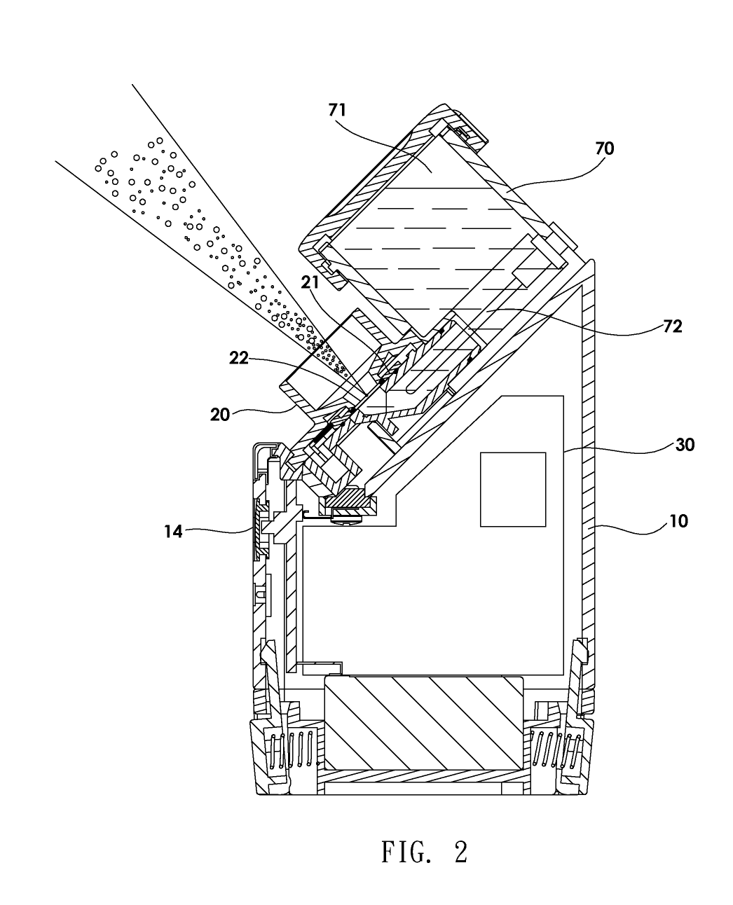

The invention discloses a method for controlling and managing a smart atomizer. Referring to FIGS. 1, 2 and 3, an atomizer has a main machine 10 that controls and manages atomized liquid spray provided by a detachable spray nozzle 20. The method for the atomizer to perform the control and management comprises primarily the following functions: automatically frequency tracing, main machine setting, abnormality detecting, event recording, and external record reading. The automatically frequency tracing involves with electrical connection of the spray nozzle 20 on the main machine 10, progressively sending out a preset frequency and plural detecting frequencies from a microcomputer 31 on a circuit board 30 in the main machine 10 by operating a frequency-tracing switch 11; and amplifying the frequencies gradually using a power amplifying unit 32 and driving a piezoelectric element 21 of the spray nozzle 20 to operate; making a current-feedback-signal generating unit 33 use a resistor R1 to detect variation of an electrical signal in an electrical connection line between the power amplifying unit 32 and the piezoelectric element 21, and generate an initial feedback signal for each the variation and plural modulation feedback signals for the microcomputer 31 to perform comparison and process, so that the microcomputer 31 uses a frequency-tracing way to take the preset frequency or one of the detecting frequencies as an operating frequency that is optimal for the piezoelectric element 21, and automatically performs resonant-frequency adjustment for the piezoelectric element 21.

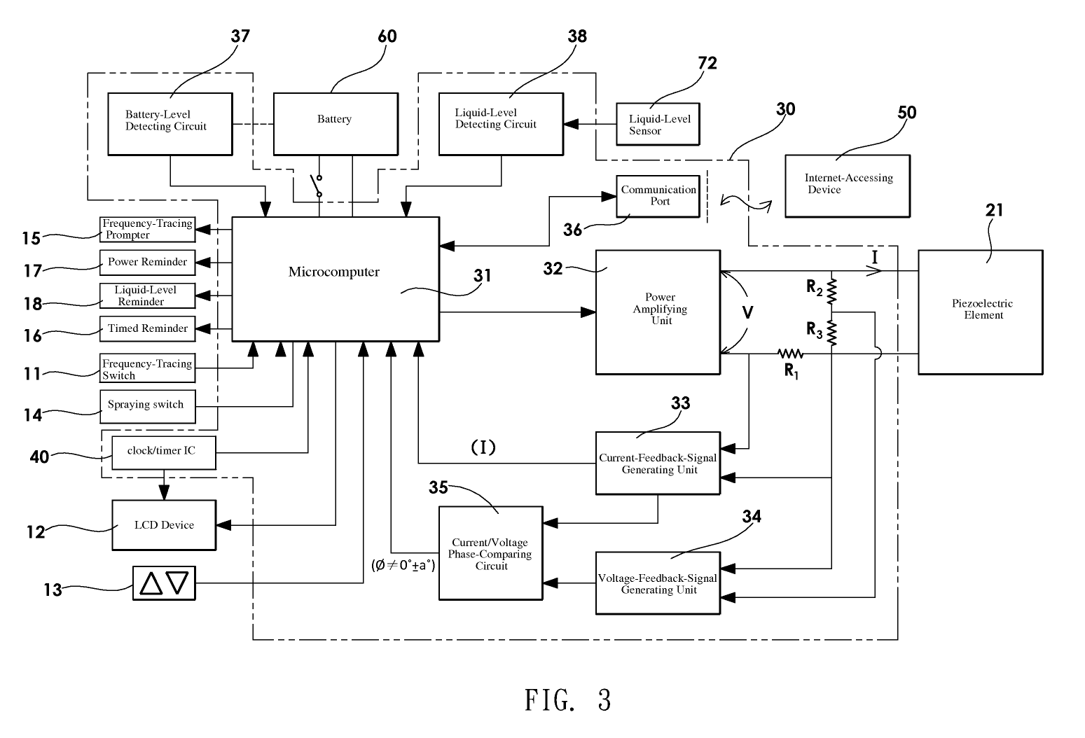

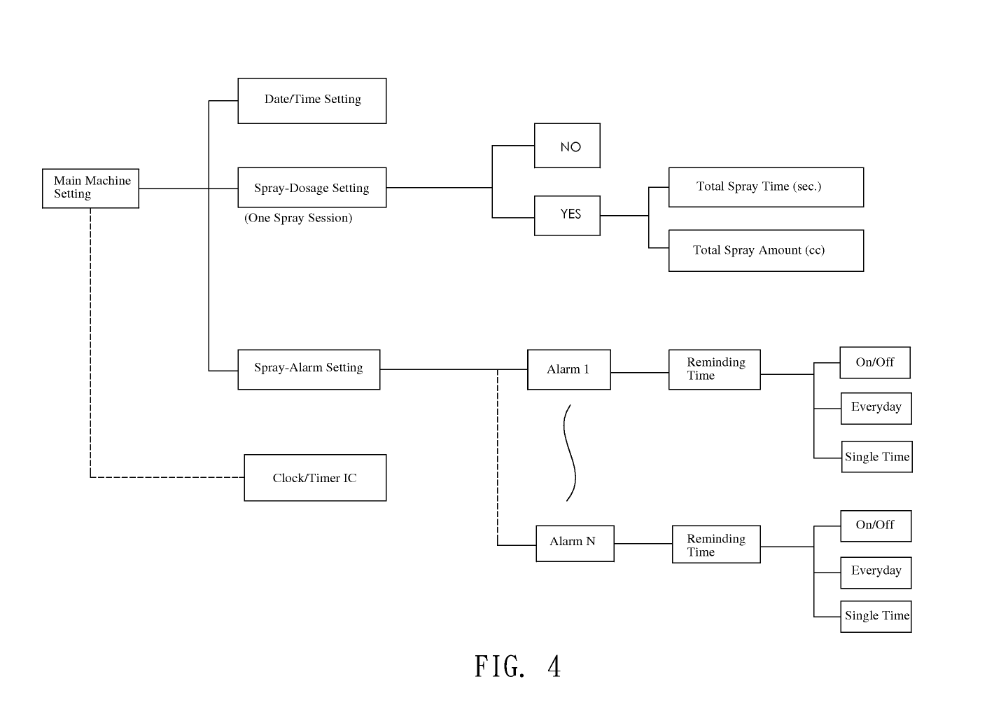

As shown in FIGS. 1, 3 and 4, the main machine setting involves performing at least date/time setting and spray-dosage setting by a clock/timer IC 40 built in or externally connected to the microcomputer 31 using setting-menu display of an LCD device 12 and operation of a setting button 13. The date/time setting involves setting or calibrating a date and a time where the atomizer is used. The spray-dosage setting involves setting a dosage of the atomized liquid dispensed during a spray session activated by a spraying switch 14. Referring to FIGS. 1 and 3, the abnormality detecting involves using at least a frequency-abnormality detecting means that comprises two resistors R2 and R3 that are on an alternating current line between the power amplifying unit 32 and the piezoelectric element 21 and are connected in parallel to the piezoelectric element 21 to detect variation of an electrical signal between the two resistors R2 and R3 in a connection line between the two resistors R2 and R3 through a voltage-feedback-signal generating unit 34; and using a current/voltage phase-comparing circuit 35 to obtain a current-waveform feedback signal from the current-feedback-signal generating unit 33 and a voltage-waveform feedback signal from the voltage-feedback-signal generating unit 34 that are compared and processed to generate a signal for determining current/voltage phase difference for the microcomputer 31, so that the microcomputer 31 triggers a frequency-tracing prompter 15 and lights up its LED when the operating frequency of the piezoelectric element 21 is abnormal to inform that the operating frequency of the piezoelectric element 21 has to be adjusted by operating the frequency-tracing switch 11 or by replacing the spray nozzle 20.

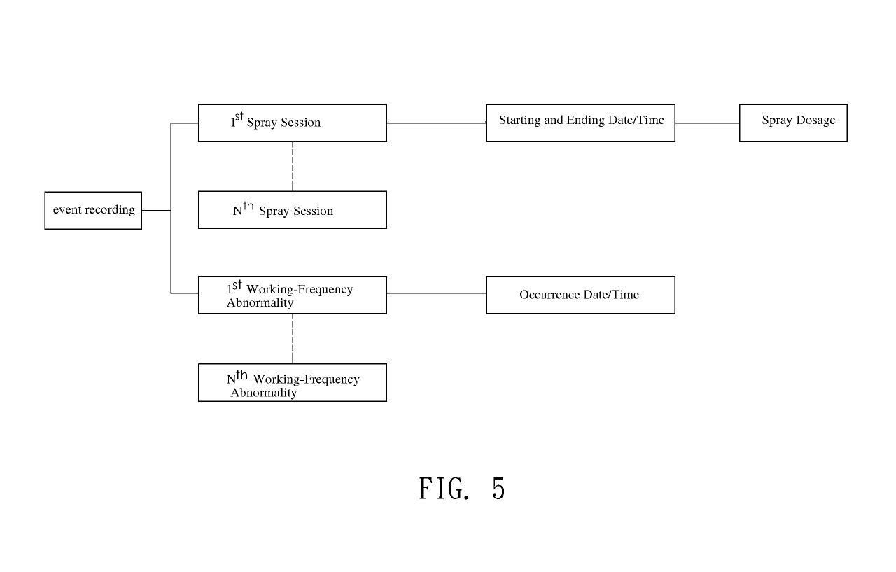

As shown in FIGS. 3 and 5, the event recording involves using a memory built in the microcomputer 31 to record at least starting and ending date/time/spray dosage for every the spray session and date/time of each abnormality occurrence of the operating frequency.

Referring to FIG. 3, the external record reading involves connecting a communication port 36 at a signal input/output end of the microcomputer 31 with an external Internet-accessing device 50, so as to read out data stored in the memory of the microcomputer 31.

Referring to FIGS. 1, 2 and 3, with the method described above, the atomizer uses automatically frequency tracing to rapidly optimize the operating frequency of the piezoelectric element 21 of the spray nozzle 20 when the spray nozzle 20 is assembled to the main machine 10 of the smart atomizer. The main machine 10 performs spray-dosage setting, so that each spray session can operate according a preset spray dosage, so as to provide consistent spray of liquid easily by operating the spraying switch 14. While the liquid is sprayed, with the abnormality detecting, the frequency-abnormality detecting means keeps detecting whether there is any abnormality of the operating frequency of the piezoelectric element 21. Thereby, whether the spray nozzle 20 works normally can be easily confirmed by whether a frequency-tracing prompter 15 gives out a prompt and what maintenance message is contained in the prompt. The method also includes functions of event recording and external record reading. The event recording stores data about the usage of the atomizer, and the external record reading allows an Internet-accessing device 50 to read out the data and/or upload the data to a website for further use as reference for external resources to review and accordingly decide subsequent use of the atomizer and/or provide assistance to the user. Thus, the use records or data of the atomizer can be used as helpful information.

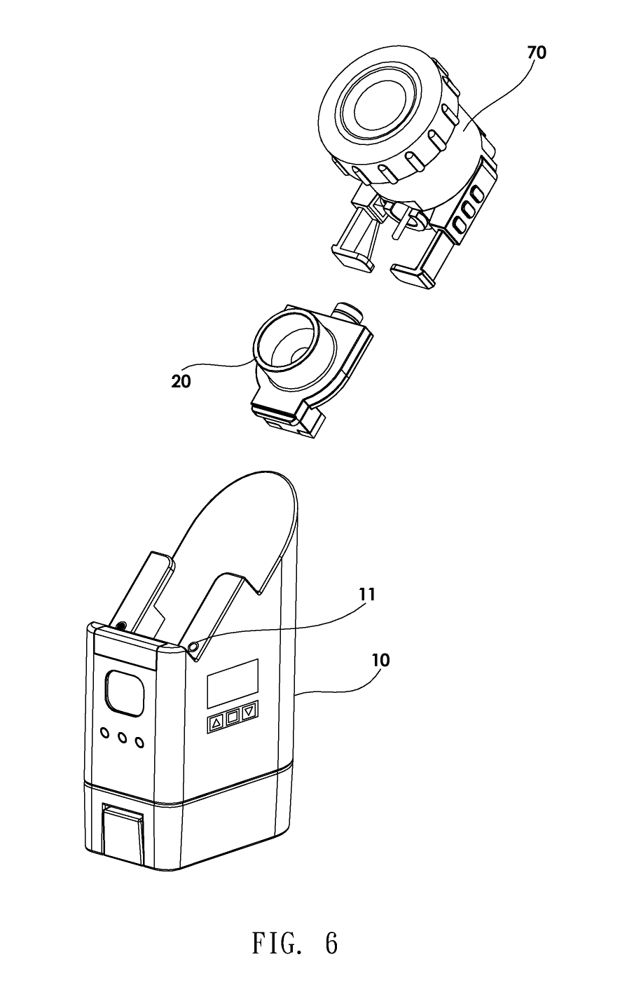

Particularly, referring to FIG. 3, in the automatically frequency tracing step, the current-feedback-signal generating unit 34 uses the electrical rule that when the piezoelectric element 21 works in resonance, its impedance (Z) is least, while the current (I) and the power (P) are greatest, to detect variation of the driving signal (current I) of the piezoelectric element 21 during the frequency tracing process and accordingly generate an analogic feedback signal. When the signal is strong, it is indicated that the operating frequency of the piezoelectric element 21 is close or equal to the resonance frequency. After the preset frequency and the detecting frequencies sent out by the microcomputer 31, and the initial feedback signal and the modulation feedback signals received by the current-feedback-signal generating unit 33 are numerally compared, the preset frequency or one of the detecting frequencies can be identified and exclusively used as the optimal operating frequency for the piezoelectric element 21. When it is necessary to detach and replace the spray nozzle 20 from the main machine 10, as shown in FIG. 6, the resonance frequency for the piezoelectric element 21 can be automatically aligned by simply operating the frequency-tracing switch 11, as shown in FIGS. 1, 2 and 3, thereby eliminating the inconvenient and potential errors caused by manual adjustment.

Referring to FIGS. 1 and 3, the abnormality detecting is done based on the electrical rule that after the adjustment, when the AC power frequency f output by the power amplifying unit 32 is equal to the natural frequency fr of the piezoelectric element 21 and the resonance state is achieved (f=fr), the piezoelectric element 21 has the least (Min) impedance (Z, ohm), and the current/voltage phase difference (φ) is zero (φ=0, when the current I is at the greatest level Max, the working power of the piezoelectric element 21 is also at the greatest level Max for the normal spray operation). Then after the spraying switch 14 is operated to make the piezoelectric element 21 work at the optimal operating frequency (the resonance frequency) to spray the atomized liquid normally, once the current/voltage phase-comparing circuit 35 notices any abnormality that is indicated by the current/voltage phase difference (φ) not equal or close to zero (φ≠0°±a°), the microcomputer 31 can instantly (NG) trigger the frequency-tracing prompter 15 to prompt the user to operate the frequency-tracing switch 11 again to readjust the working (resonance) frequency of the piezoelectric element 21. If repeated adjustments have been done as failure (failing to align the working frequency to the resonance frequency) and the frequency-tracing prompter 15 keeps giving prompts, the user can be sure that the spray nozzle 20 needs to be maintained or replaced. Thereby, the normal operation of the atomizer can be conveniently managed and maintained in virtue of the automatic frequency-abnormality detection (the piezoelectric element 21 being in the non-resonance state).

In the embodiment as described preciously, as shown in FIG. 3, when the operating frequency of the piezoelectric element 21 is abnormal, the microcomputer 31 may alternatively show a frequency-abnormality signal in the LCD device 12 so as to provide prompts similarly and eliminate the use of the frequency-tracing prompter 15.

In the embodiment as described preciously, as shown in FIGS. 1, 3 and 4, the main machine setting comprises spray-alarm setting that involves setting a reminding time for using the atomizer every day and when the reminding time is up, making the microcomputer 31 trigger a timed reminder 16, which may be a buzzer BZ, to operate. Thereby, every day at the preset time of using the atomizer, the user can be reminded by the sound of the timed reminder 16, and timely perform the inhalation.

In the embodiment as described preciously, as shown in FIGS. 1 and 3, the abnormality detecting also comprises power-abnormality detecting. The power-abnormality detecting involves taking a battery-level detecting circuit 37 that is configured to detect a power level of a battery 60 as a signal input end of the microcomputer 31, and taking an LED-equipped power reminder 17 as a detecting end of the microcomputer 31. Thereby, when the battery 60 becomes low-power and may hinder the piezoelectric element 21 from operating normally, the battery-level detecting circuit 37 detecting this situation can inform the microcomputer 31 so that the microcomputer 31 can light up the power reminder 17 to remind the user of replacing the battery 60, thereby prevent the atomizer from failing.

Referring to FIG. 3, when the battery-level detecting circuit 37 detects that the battery 60 becomes low-power, the microcomputer 31 may alternatively show a low-power message in the LCD device 12. This can similarly remind the user of replacing the battery 60.

In the embodiment as described preciously, as shown in FIGS. 1, 2 and 3, the abnormality detecting also comprises liquid-lack detecting. The liquid-lack detecting involves using a liquid-level sensor 72 in a liquid reservoir 71 of a liquid refill 70 of the spray nozzle 20 as an input end of a liquid-level detecting circuit 38. The liquid-level detecting circuit 38 has an output end electrically connected to the microcomputer 31, and an LED-equipped liquid-level reminder 18 is used as an output end of the microcomputer 31. Thereby, when the liquid in the liquid reservoir 71 of the liquid refill 70 gets consumed to a certain extent, the liquid-level detecting circuit 38 can output a low-level signal to the microcomputer 31 according to the detection of the liquid level in the liquid reservoir 71 performed by the liquid-level sensor 72, so that the microcomputer 31 can light up the liquid-level reminder 18 to inform that refill needs to be done. When the liquid reservoir 71 is almost empty, the microcomputer 31 can even stops the spraying switch 14 and automatically turns off the piezoelectric element 21, so as to prevent the piezoelectric element 21 and/or the nozzle plate 22 from getting damaged due to waterless operation. Additionally, when the liquid-level detecting circuit 38 outputs the low-level signal to the microcomputer 31, the microcomputer 31 can show the low-water message through the LCD device 12 so as to similarly provide refill reminding function.

In the embodiment as described preciously, as shown in FIGS. 1, 3 and 4, the spray-dosage setting performed by the main machine setting involves making the microcomputer 31 automatically time a period for each the spray session on which the spraying switch 14 is turned on (pressed down) so as to decide the starting and ending time for the spray session as defaults, and control a total dispensed amount of one the spray session from the starting time to the ending time by setting a total spray time according to a spray flow as a constant and a statistic relation that the spray flow multiplied by the period is the spray dosage. With this function, each spray session can be controlled to give equivalent liquid dispensation by automatically timing the specified or accumulated operation (being pressed down) time of the spraying switch 14.

In the embodiment as described preciously, as shown in FIGS. 1, 3 and 4, the spray-dosage setting performed by the main machine setting involves making the microcomputer 31 automatically time a period for each the spray session on which the spraying switch 14 is turned on (pressed down) so as to decide the starting and ending time for the spray session as defaults, and control a time length required by delivering a total dispensed amount of one the spray session from the starting time to the ending time by setting a total spray time according to a spray flow as a constant and a statistic relation that the spray flow multiplied by the period is the spray dosage. With this function, each spray session can be controlled to give equivalent liquid dispensation by automatically timing the specified or accumulated operation (being pressed down) time of the spraying switch 14.

In the embodiment as described preciously, as shown in FIG. 3, the communication port 36 for the external record reading is a Bluetooth port and/or a USB port, and the Internet-accessing device connected to the communication port 36 for reading out the data is a smartphone, a laptop PC or a desktop PC that is preloaded with an operational application. By operating the application, the record data stored in the memory of the microcomputer 31 can be read out for direct use. For example, the caregiver or the family member of the atomizer's user can provide the user with proper assistance according to the read-out data. Also, the data can be uploaded to a website where the user has registered through Internet connection for remote external resources (e.g. medical professionals, pharmaceutical businesses, atomizer manufacturers, insurance companies, etc.) to use.

While the invention has been described in terms of preferred embodiments, those skilled in the art will recognize that the invention can be practiced with modifications within the spirit and scope of the appended claims.

What is claimed is:

1. A method for controlling and managing a smart atomizer, being applied to a main machine of the atomizer to control and manage usage of atomized liquid at a spray nozzle, comprising:
automatically frequency tracing, involving: with electrical connection of the spray nozzle on the main machine, progressively sending out a preset frequency and plural detecting frequencies from a microcomputer in the main machine by operating a frequency-tracing switch; and amplifying the frequencies gradually using a power amplifying unit and driving a piezoelectric element of the spray nozzle to operate; making a current-feedback-signal generating unit use a resistor to detect variation of an electrical signal in an electrical connection line between the power amplifying unit and the piezoelectric element, and generate an initial feedback signal for each the variation and plural modulation feedback signals for the microcomputer to perform comparison and process, so that the microcomputer uses a frequency-tracing way to take the preset frequency or one of the detecting frequencies as an operating frequency that is optimal for the piezoelectric element, and automatically performs resonant-frequency adjustment for the piezoelectric element;
main machine setting, involving performing at least date/time setting and spray-dosage setting by the microcomputer using setting-menu display of a display and operation of a setting button, wherein the date/time setting involves setting or calibrating a date and a time where the atomizer is used, and the spray-dosage setting involves setting a dosage of the atomized liquid dispensed during a spray session activated by a spraying switch;
abnormality detecting, involving using at least a frequency-abnormality detecting means that comprises two resistors that are on an alternating current line between the power amplifying unit and the piezoelectric element and are connected in parallel to the piezoelectric element to detect variation of an electrical signal between the two resistors in a connection line between the two resistors through a voltage-feedback-signal generating unit; and using a current/voltage phase-comparing circuit to obtain a current-waveform feedback signal from the current-feedback-signal generating unit and a voltage-waveform feedback signal from the voltage-feedback-signal generating unit that are compared and processed to generate a signal for determining current/voltage phase difference for the microcomputer, so that the microcomputer triggers a frequency-tracing prompter when the operating frequency of the piezoelectric element is abnormal to inform that the operating frequency of the piezoelectric element has to be adjusted by operating the frequency-tracing switch or by replacing the spray nozzle;
event recording, involving using a memory built in the microcomputer to record at least starting and ending date/time/spray dosage for every the spray session and date/time of each abnormality occurrence of the operating frequency; and
external record reading, involving connecting a communication port at a signal input/output end of the microcomputer with an external Internet-accessing device, so as to read out data stored in the memory of the microcomputer.

2. The method of claim 1, wherein the microcomputer is configured to show a frequency-abnormality signal through the display when the operating frequency of the piezoelectric element is abnormal.

3. The method of claim 1, wherein the main machine setting further comprises spray-alarm setting that involves setting a reminding time for using the atomizer every day and when the reminding time is up, making the microcomputer trigger a timed reminder to operate.

4. The method of claim 1, wherein the abnormality detecting further comprises power-abnormality detecting that involves taking a battery-level detecting circuit that is configured to detect a power level of a battery as a signal input end of the microcomputer, and taking a power reminder as a detecting end of the microcomputer.

5. The method of claim 4, wherein when the battery-level detecting circuit detects the power level of the battery as low, the microcomputer shows a low-power message through the display.

6. The method of claim 1, wherein the abnormality detecting further comprises liquid-lack detecting that involves using a liquid-level sensor in a liquid reservoir of a liquid refill of the spray nozzle as an input end of a liquid-level detecting circuit, wherein the liquid-level detecting circuit has an output end electrically connected to the microcomputer, and a liquid-level reminder is used as an output end of the microcomputer.

7. The method of claim 6, wherein the liquid-level detecting circuit outputs a low-level signal to the microcomputer, and the microcomputer shows a low-water message through the display.

8. The method of claim 1, wherein the spray-dosage setting performed by the main machine setting involves making the microcomputer automatically time a period for each the spray session since a time point on which the spraying switch is turned on so as to decide the starting and ending time for the spray session as defaults, and control a total dispensed amount of one the spray session from the starting time to the ending time by setting a total spray time according to a spray flow as a constant and a statistic relation that the spray flow multiplied by the period is the spray dosage.

9. The method of claim 1, wherein the spray-dosage setting performed by the main machine setting involves making the microcomputer automatically time a period for each the spray session since a time point on which the spraying switch is turned on so as to decide the starting and ending time for the spray session as defaults, and control a time length required by delivering a total dispensed amount of one the spray session from the starting time to the ending time by setting a total spray time according to a spray flow as a constant and a statistic relation that the spray flow multiplied by the period is the spray dosage.

10. The method of claim 1, wherein the communication port allowing the data to be read out is a Bluetooth port and/or a USB port, and the Internet-accessing device connected to the communication port for reading out the data is a smartphone, a laptop PC or a desktop PC that is preloaded with an operational application.
